(19) United States
(12) Patent Application Publication
(10) Pub. No.: US 2008/0012186 A1
(43) Pub. Date: Jan. 17, 2008

(54) Method For Producing Molded Plastic Articles

(75) Inventors: Helmut Potente, Paderborn (DE); Hans-Peter Heim, Verl (DE); Helmut Ridder, Delbrueck (DE)

Correspondence Address: COHEN, PONTANI, LIEBERMAN & PAVANE, 551 FIFTH AVENUE, SUITE 1210, NEW YORK, NY, 10176, US

(73) Assignee: Universitaet Paderborn, Paderborn (DE)

(21) Appl. No.: 11/597,466

(22) PCT Filed: May 23, 2005
(86) PCT No.: PCT/DE05/00948

§ 371 Date: Feb. 5, 2007

(30) Foreign Application Priority Data
May 24, 2004 (DE) 10 2004 025842.2

(51) Int. Cl. B29C 44/16

(52) U.S. Cl. 264/531; 264/523

(57) ABSTRACT

In a process for producing plastic components, a molded plastic article with a hollow space and relatively thick walls is molded in a first step, and, in an additional step, a predetermined fluid pressure is applied to the interior of the hollow space in the molded plastic article to enlarge it so that the thicknesses of the walls of the hollow space are reduced.

The invention pertains to a process for producing molded plastic articles.

Many plastic components are produced by gas injection processes. The gas injection technique is a special injection-molding process, in which a hollow space is formed by means of a pressurized fluid after or during the actual injection step. The gas injection process is normally used when it is desired to achieve uniform molding of thick-walled articles without sink marks or geometries with high torsional rigidity. Additional advantages are to be found in the large freedom of design, in the uniform shrinkage and thus lack of distortion, and in the shorter cycle times in comparison with thick-walled solid parts. The weight of the article and the number of joint lines are also reduced.

Gas injection processes are known under process names or brand names such as Airmold, Airpress, CINPRESS, GAIN, GID, and GIP. There are basically two different processes:

the blow-up process, a standard gas injection process and core-pull process, and

the blow-out process (a secondary cavity process) or counterflow process.

There are also a large number of variants of these processes.

An important variable in gas injection processes is the wall thickness of the hollow spaces in the finished part. This influences the consumption of material, the required cooling time, the surface quality, and the mechanical properties and thus the cost per part. Various ways of controlling the wall thickness have already been discussed, e.g., the temperature of the mold or of the melt. Various studies have been conducted in recent years by various institutes and companies to find ways to control the process parameters which affect wall thickness and the formation of the hollow space. The results can be found in the technical literature.

WO 03/011557 discloses a process in which, after the plastic has been injected and the gas has been forced in, a second step is carried out in which a valve is opened to expel a portion of the plastic, and then the hollow plastic body is solidified by the application of additional pressure.

DE 199 63 896 describes a process for producing a bumper by injection-molding and blow-molding. Starting from a conventional injection-molded part, the process serves essentially to avoid sink marks. In contrast to the gas injection blow-up process, the external contour of the workpiece is not changed by the blow-molding. Instead, according to the principle of the process, ribs are welded onto a front plate by using the connected gas channel to displace melt from the component and to produce the joint.

EP 0 545 692 describes an injection-molded object with a high-quality appearance. To avoid sink marks on the surface of the base body which is opposite the thick-walled part, e.g., a stiffening rib, the thick-walled part has a hollow part. A pressurized gas is introduced into this hollow part, and the pressure is held until the molten plastic cools and the volume of the material has almost completely stopped shrinking.

DE 199 83 733 describes the production of blow-molded articles by an injection-molding process. The expansion occurs here by blowing compressed gas into the melt.

Processes are also described in which gas is injected into the molten material at the molding machine nozzle or into the flow or directly into the molten material. The processes described in EP 0 624 121 do not make it possible in practice to create flat molded articles with surfaces which do not reveal the presence of ribs, dents, or webs on the opposite side. Accordingly, plastic components produced by these types of processes cannot meet the requirements of the automotive industry, because “class A” surface qualities cannot be achieved.

Other methods for producing lightweight, hollow molded articles are extrusion blow-molding and injection blow-molding. These involve the blowing of a blank with air, which is applied from the inside to force the blank to conform to the walls of the mold. The preform thus obtained by standard injection-molding is then blown up in another step of the process. In the case of extrusion blow-molding, an extruded preform is blown up.

Blow-up processes are used primarily to produce thin-walled hollow plastic articles. In particular, this process is used to produce plastic bottles and large-volume containers, sports equipment, and children's toys. Typical extrusion blow-molded products are, for example, detergent bottles and plastic fuel containers; typical injection blow-molded products are, for example, PET beverage bottles. A process of this type is described in, for example, U.S. Pat. No. 5,954,224.

DE 198 25 104 describes a plastic container and a process for its production. Here channels are blown out along the desired path. The size of the hollow cross section is not increased.

According to the previous prior art, the conventional gas injection technique makes it possible to produce thin-walled, complex components without hollow spaces or relatively thin-walled hollow spaces of simple external geometry. When a gas injection process is used to produce thick-walled components with relatively thick-walled hollow spaces, however, the cross section of the hollow space deviates increasingly from the external contour. The cross-sectional area of the gas bubble cannot be adjusted freely, and only a certain maximum end value can be reached, which depends on the geometry of the gas guide channel and on the selected processing parameters. As a result, the residual wall thickness of the polymer may not be allowed to fall below a certain minimum value.

It is true that extrusion blow-molding can produce relatively complex hollow bodies with thin walls. It is impossible, however, to connect thin-walled, precise geometries to the hollow space by this process without the use of additional steps.

Injection blow-molding makes it possible to produce precise, very thin-walled hollow bodies. Because the preform is produced by standard injection-molding, however, it is impossible to realize hollow spaces and thus corresponding blow-up geometries in the preform which cannot be obtained by the use of cores in standard injection-molding.

Proceeding from this prior art, the invention is based on the task of developing a process for producing plastic components with hollow spaces of complex geometries.

The task is accomplished according to the invention by the processes or process steps described in the claims.

An essential idea of the invention consists in combining the gas injection technique with a subsequent blow-up process. A blow-up process downline from the gas injection process makes it possible to produce functional hollow spaces with extremely thin walls. A fundamental idea is that the thin-walled areas which represent the walls of the functional hollow space are formed by means of an additional stretching, drawing out, and/or elongation of the webs or hollow space walls formed during the gas injection process. In a first step of the process, therefore, a molded article is produced by, for example, the standard gas injection technique. Then the mold cavity is enlarged considerably, and by means of the renewed application or holding of the gas pressure, the extremely thin-walled functional channel can be produced by enlarging the size of the hollow space.

The process also makes it possible to connect thin-walled, precision component areas to the hollow space geometry. The inventive process makes it possible to obtain a hollow space geometry with a very large cross section and thin walls.

The combination of the gas injection process and the blow-up process therefore offers superior possibilities of expanding automated production of plastic components and thus also of increasing their range of applications and possibilities.

In particular, it is also possible to produce shapes which cannot so far be produced by injection molding. Molded articles which are favorable for production by the gas injection process are long, slender, thick-walled parts, e.g., rod-shaped articles; flat molded articles with gas channels as flow aids or with ribbing; parts with mass accumulations; and tubing. Thin-walled molded articles require thick-walled flow channels, through which the gas can flow. The penetration of the gas into thin-walled areas should be avoided as effectively as possible.

The inventive process allows in particular the preparation of a preform with an essentially two-dimensional component area connected to at least one wall of a hollow space, whereupon the mold cavity defining the hollow space geometry is enlarged, and the hollow space is expanded by the introduction of a pressurized fluid, which has the effect of reducing the wall thickness of the hollow space. A gas or a fluid with a liquid phase can be used as the fluid. Alternatively, the fluid can be a polymer melt solidifying in the hollow space, and the pressure can also be applied by the foaming of the polymer melt.

The invention is explained in greater detail on the basis of the drawing, which shows schematic diagrams of various plastic components.

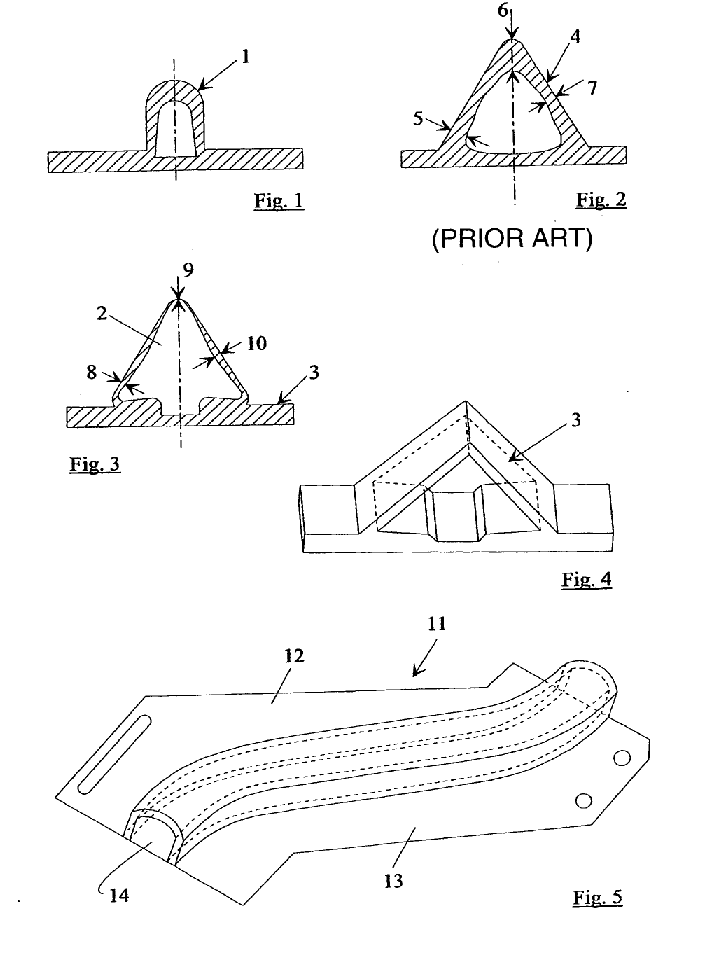

FIG. 1 shows a cross section of a preform produced by a gas injection process;

FIG. 2 shows a cross section of a plastic component produced by a gas injection process;

FIG. 3 shows the preform of FIG. 1 after a blow-up process;

FIG. 4 shows an isometric view of the molded plastic article of FIG. 3; and

FIG. 5 shows an example of a hollow space with a complex geometry.

The gas injection technique is a special injection-molding process, according to which the injection mold is first filled with a defined amount of polymer, and then a fluid is injected into the still-molten phase of the molding charge of polymer. As a result of the injection of gas, the areas of the mold which have remained unfilled up to this point are filled, in that a hollow space is formed in the so-called “gas guide channel”. A gas can be used as the fluid, but it is also possible to use, for example, water, oil, or the like. The subsequent blow-up process, which is carried out after the gas injection process, makes it possible to produce functional hollow spaces with large cross sections and thin walls. Through the additional stretching, drawing out, and/or elongation of the webs or walls which have formed, the walls of the hollow space are thinned out. This applies equally to all process variants of the gas injection technique.

First, a molded article 1 is produced by the conventional gas injection technique or by one of the above-mentioned variants of the blow-up or blow-out processes (see FIG. 1). Then, the size of the mold cavity is significantly increased, and by the renewed application of gas pressure or by the holding of that pressure or by a variation of the gas pressure, the extremely thin-walled functional channel 2 is produced in the plastic component 3 by stretching, drawing down, and/or elongation (compare FIGS. 3 and 4). For the blow-up process, it is necessary for the temperature of the molded article to be in the thermoelastic or thermoplastic range of the plastic being processed. This can be done by rapidly increasing the size of the mold cavity and by blowing the article up immediately, so that the heat of the molded article left over from the gas injection process can be exploited. Otherwise, the proper temperature can be ensured by reheating the article by the use of a heating system such as a radiant heater or convection heater; by thermal conduction; or by means of other energy sources such as high-frequency or microwave radiation or the like. The mold can be either open or closed.

As a result, a gas guide channel 2 with a much larger overall cross section is produced. FIGS. 2 and 3 show the difference between the residual wall thicknesses achieved by the use of the two production processes.

In the case of the plastic component 4 produced by a conventional gas injection process, the wall thicknesses indicated by the double arrows 5, 6, 7 are 2.54 mm, 4.66 mm, and 1.6 mm. In contrast, the wall thicknesses of the plastic component 3 produced by the inventive process indicated by the double arrows 8, 9, 10 are reduced to 0.8 mm, 0.3 mm, and 1.0 mm, thus by a factor between 1.6 and 15 in this exemplary embodiment. Experiments have also shown that reduction factors of up to approximately 50 can be achieved.

It is also obvious from this comparison that the wall thicknesses with the maximum values are reversed. Whereas component 4 according to Figure shows a maximum wall thickness at its free tip between the double arrow 6, component 3 produced according to the inventive process shows a minimum thickness at this point between the double arrow 9. The same reversal is observed in the more-or-less central parts of the free sides of the triangles. Whereas a minimum wall thickness is found between the double arrow 7, a maximum wall thickness is present in component 3 between the double arrow 10.

The comparison shows in particular that, in the case of component 3, the internal contour of the hollow space 2 matches the external contour almost perfectly.

It can be seen that, by means of the new process, hollow spaces with much thinner residual wall thicknesses can be produced. This means in turn that the desired geometry can be obtained with much less material. Because of the thinness of the walls which can be achieved by means of the process, the molded articles can be produced with very short cooling times. This leads to shorter cycle times overall and thus to lower production costs.

The process also makes it possible to produce molded articles 11 of the same high precision and complexity as parts produced by standard injection molding without a hollow space. Thus, as shown by way of example in FIG. 5, the essentially two-dimensional areas 12, 13 can be connected to a hollow space 14.

It is also possible to produce hollow spaces 14 with a complexity of internal contour and original geometry comparable to those known from blow-molding (compare 3D blow-molding). This goes far beyond the geometric variants which can be produced by injection blow-molding with the preform process.

It is also easy to combine the three previously mentioned advantages, as the exemplary embodiment of FIG. 4 shows. The article shown here cannot be produced by injection blow-molding.

It is possible to use a fluid other than a gas at any point in the process. Water or oils can be used for this purpose. In addition, the fluid can also be polymer melt, which solidifies into a solid mass after the cavity has been enlarged or which, before solidification, is foamed up by means of a blowing agent as the cavity is being enlarged.

1.-9. (canceled)

10. A process for producing a plastic component, the process comprising:
in a first step, producing a molded plastic article with a cavity bounded by cavity walls having a thickness; and
in a subsequent step, introducing a fluid into said cavity at a predetermined pressure so that the cavity is enlarged and the thickness of the cavity walls is reduced.

11. The process of claim 10 wherein the thickness of the cavity walls is reduced by at least one of stretching, drawing out, and elongation.

12. The process of claim 10 further comprising holding said molded plastic article in at least one of a thermoelastic and a thermoplastic temperature range during at least one of said steps.

13. The process of claim 10 wherein said first step comprises filling a mold space with plastic melt and introducing a fluid into said plastic melt to form said cavity, and said subsequent step comprises applying a predetermined internal pressure to said fluid to enlarge said cavity by at least one of stretching, drawing out, and elongation.

14. The process of claim 10 wherein the molded plastic article comprises at least one essentially two-dimensional component area connected to at least one of said cavity walls.

15. The process of claim 10 wherein the fluid is a gas.

16. The process of claim 10 wherein the fluid is a liquid.

17. The process of claim 10 wherein the fluid is a polymer melt which solidifies in the cavity.

18. The process of claim 10 wherein the fluid exerts pressure by foaming of the polymer melt.
